(19) United States
(12) Patent Application Publication
(10) Pub. No.: US 2017/0357291 A1
(43) Pub. Date: Dec. 14, 2017

(54) AUXILIARY ATTACHMENTS PARALLEL TO THE DISPLAY SCREEN OF A PORTABLE ELECTRONIC DEVICE

(71) Applicant: MUNIR Q. ZAQQA, AMMAN (JO)

(72) Inventor: MUNIR Q. ZAQQA, AMMAN (JO)

(21) Appl. No.: 15/181,441

(22) Filed: Jun. 14, 2016

(51) Int. Cl. G06F 1/16

(52) U.S. Cl. CPC G06F 1/1656; G06F 1/1616; G06F 1/1681; G06F 1/1654

(57) ABSTRACT

An embodiment being related to an arrangement of portable electronic devices and computing platforms. It describes attachments of auxiliary utilities in parallel to the display screen. These utilities may be made of commonly available hardware or of future developments and inventions. The auxiliary attachments are connected in a manner to allow them to be bent forward and backward, rotated, folded against or detached from the electronic device using connections that are able to communicate and transfer data and energy between the different components.

### BACKGROUND

### Field of the Described Embodiment

The described embodiment is related to portable electronic devices and computing platforms. In particular, it describes a method for improving the functionality while preserving the portability of the devices.

### Related Art

Since the computer was invented its development emphasized smaller size. A step forward was the introduction of the notebook computer which consists of a body with overlaid keyboard that folds against a similarly sized screen. Further developments resulted in smaller electronic devices that integrate the whole electronic components and the screen in a single box as seen with computer tablets and smart phones. Additional hardware components are however needed for various functions and are usually added by linking them via a connection such as a USB port. The added hardware is not integrated with the main electronic device unit and has to be moved separately. The purpose of this invention is to have integrated hardware that preserves the portability and the elegance of the portable electronic devices and computing platforms.

### SUMMARY OF THE DESCRIBED EMBODIMENT

The “hardwarebook” adds auxiliary attachments to regular portable electronic devices such as notebooks in parallel to the display screen. This allows the integration of hardware utilities according to need while preserving the portability of the devices. The auxiliary utilities can be constructed in a manner to have similar outside appearance to the display screen. The auxiliary attachments can be opened and folded and can be rotated and if needed detached and then replaced with other components. The attachments also perform bidirectional data communication, and if needed energy transfer, with the main body of the electronic device.

### BRIEF DESCRIPTION OF THE DRAWINGS

FIG. 1 shows a perspective view of the hardwarebook 1 with two auxiliary attachments 2 and 3 and a display screen 4 being attached to a notebook 5.

FIG. 2 shows one of the auxiliary attachments 3 and a display screen 4 being folded against the notebook 5 while auxiliary attachment 2 remains open, while in FIG. 3 both auxiliary attachments are totally folded making the unit more portable.

FIG. 4 shows a portable electronic device 6 attached to a single auxiliary attachment 2 and a parallel display screen 4.

FIG. 5 shows a portable electronic device 6 attached to a display screen 4 and a single auxiliary attachment 2 using a different configuration that allows folding of the auxiliary attachment to the side, while in FIG. tithe auxiliary attachment 2 is connected to allow folding to the front of the device.

FIG. 7 shows an example hardwarebook with auxiliary attachments consisting of a clock land a solar charging unit 8 attached to a notebook 5

### DETAILED DESCRIPTION

The embodiments as generally described and illustrated may be arranged in a variety of designs and shapes and configurations in addition to the described examples. Thus the described illustrations and examples are not intended to limit the embodiment but rather to illustrate and show how it can function.

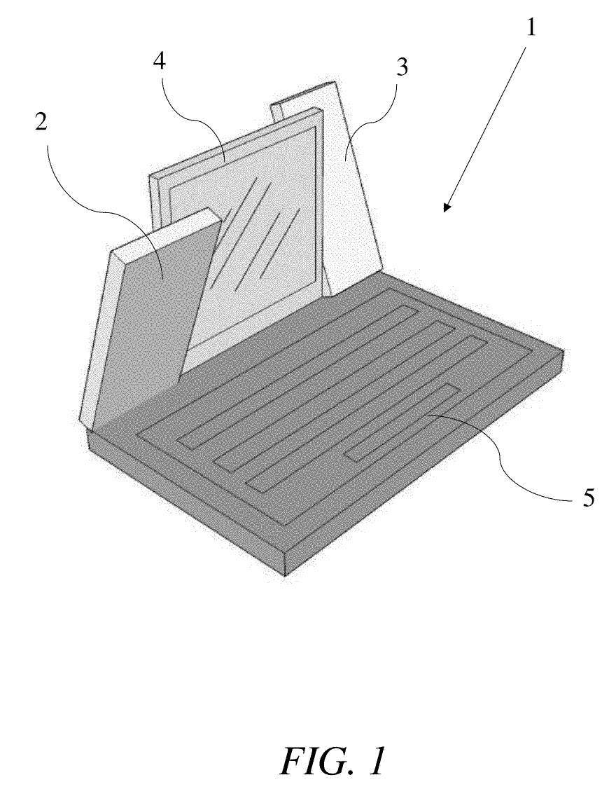

Referring to FIG. 1 the hardwarebook 1 shows an example of a base unit 5 which encloses the processing and memory components required for the portable electronic device with an overlying keyboard and two auxiliary units 2 and 3 attached in parallel to the display screen 4. Examples of portable electronic devices 5 that serve as base unit include notebook computers and gaming consoles. The auxiliary units can be folded (bent forward and backward) separately as seen in the illustration. They can also be rotated or detached according to pivotal connections. The attachments also allow bidirectional communication with the base unit using standard protocols to allow exchange of data and power with the base unit. The auxiliary units can be constructed of any hardware device currently available in the market and may include future developments and inventions. Examples of auxiliary utilities include a clock, loud speakers, a printer, scanners such as for business cards or for security verification, magnetic and security card readers, sensors for example of heat or movements, remote controls for example for robot control, a solar charger, projectors with possible 3 dimensional projectors, a storage device like a safe that can be opened and locked by the main body or simply a box to store things. The outside covering of the auxiliary unit can be constructed of a protective material such as hard plastic to encase the hardware component in a variety of shapes and designs that allow the described movements of folding and rotation.

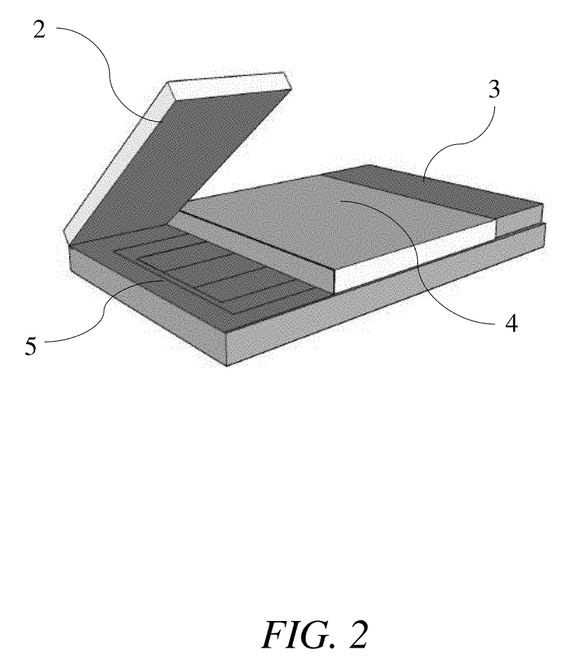

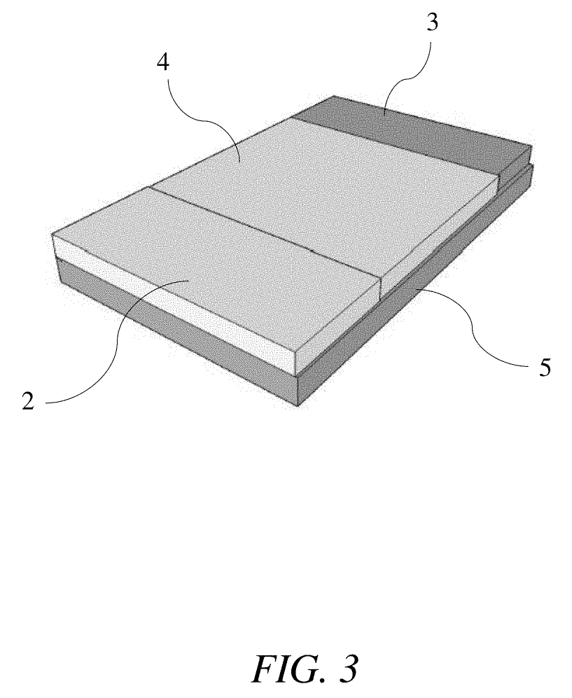

FIG. 2 shows the hardwarebook partially folded. Any of the auxiliary utilities and the screen can be folded separately, or rotated or detached as needed. FIG. 3 shows the hardwarebook with all attachments and the screen completely folded to enhance the portability and protection of the unit.

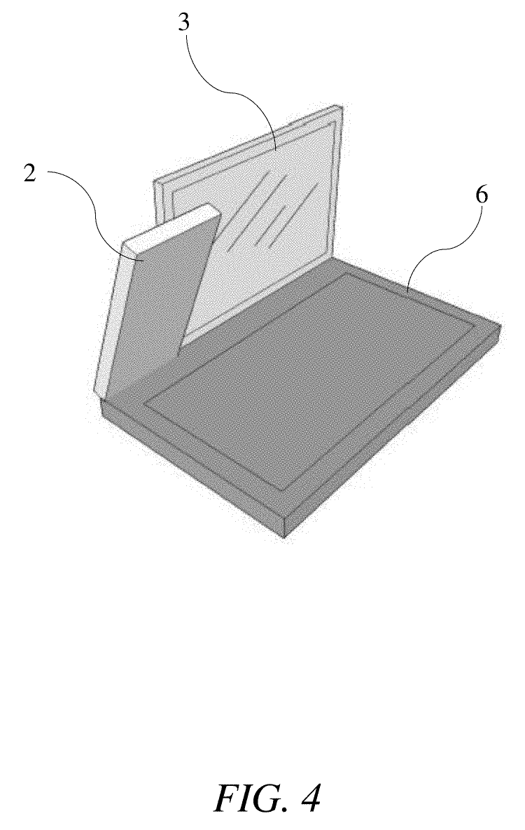

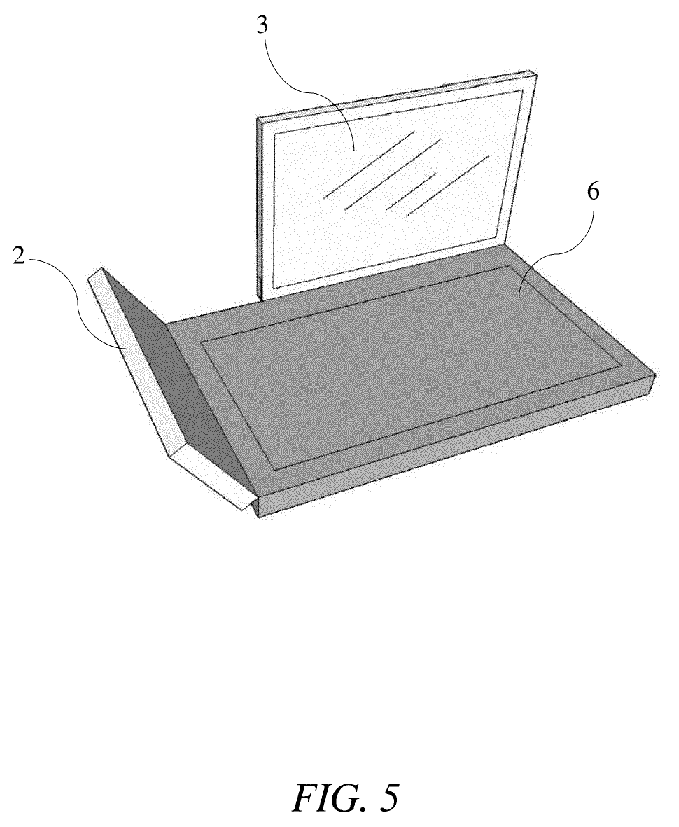

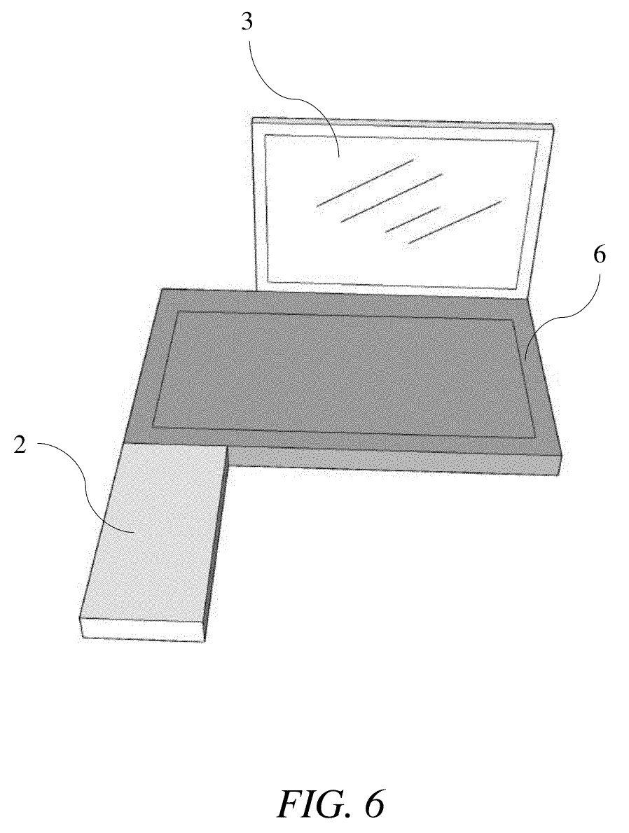

FIG. 4 shows a different configuring with a single auxiliary unit. The number of units in the design can be increased or decreased according to the need. The single auxiliary attachment is connected to a portable electronic device 6 and is partially folded. FIG. 5 shows a different configuration of the auxiliary unit with connection to the side of the base unit. This allows folding of the attachment to the side. In a similar manner, the auxiliary unit can be connected to the front as shown in FIG. 6 to allow folding to the front of the unit. The connected auxiliary attachment can be to the left or the right side of the screen.

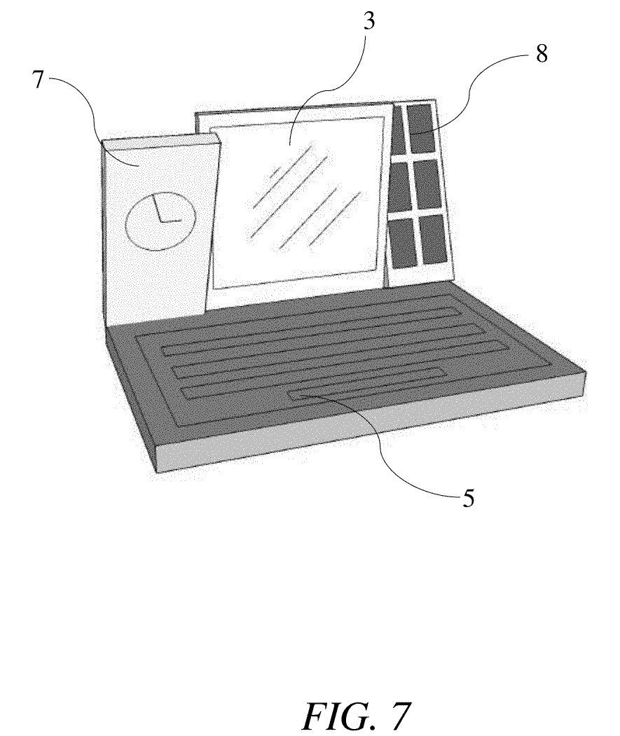

FIG. 7 shows an example hardwarebook attached to two sample auxiliary utilities compromised of a clock and a solar charger.

What is claimed is:

1. One or more auxiliary attachments in parallel to the display screen in portable electronic devices and computing platforms. The attachments are connected to the base unit in a manner to allow movements such as folding and bending forward and backward or rotation and also allow removal of the attachment and replacement with a different one. These connection points also allow communication with the main body for bidirectional exchange of data and the transfer of energy between the components. The auxiliary attachments can be made of currently available hardware devices and utility tools available in the market or of future developments and inventions.
